(19) United States
(12) Patent Application Publication
(10) Pub. No.: US 2007/0174123 A1
(43) Pub. Date: Jul. 26, 2007

(54) APPARATUS AND METHOD FOR INCENTIVE MARKETING

(76) Inventor: Harry J. Dorr, Jonesborough, TN (US)

Correspondence Address: Michael E. Sellers;Gable Gotwals, 10th Floor, 100 W. 5th Street, Tulsa, OK, 74103, US

(21) Appl. No.: 11/621,452

(22) Filed: Jan. 9, 2007

Related U.S. Application Data
(60) Provisional application No. 60/757,622, filed on Jan. 10, 2006.

(51) Int. Cl. G06Q 30/00

(52) U.S. Cl. 705/14

(57) ABSTRACT

An incentive apparatus and method provides a purchaser of fuel at a store, such as a convenience store, a chance to win an award. A unique identifier is assigned to the fuel purchase. The fuel purchaser provides the unique identifier to a kiosk or other customer interface device located in the store. The kiosk checks the unique identifier and provides the fuel purchase an opportunity to win an award based on chance if the unique identifier is validated. In one embodiment, the fuel purchaser wins an award if a randomly generated number matches a portion (such as the cents portion) of the fuel purchase amount. The kiosk may also be configured to dispense a short duration coupon to the fuel purchaser that is redeemable within a period of 24 hours or less.

### CROSS-REFERENCE TO RELATED APPLICATION

This application is based upon and claims priority to U.S. Provisional Patent Application No. 60/757,622 which was filed on Jan. 10, 2006.

### FIELD OF THE INVENTION

The present invention relates generally to incentive marketing programs. More particularly, the invention relates to an apparatus and method for increasing business at stores that sell fuel for automobiles, such as convenience stores and grocery stores, through a unique incentive marketing program.

### BACKGROUND OF THE INVENTION

The convenience store industry has established itself as the primary provider of fuel for vehicular operation. Many grocery stores and so-called “mega-stores” also market fuel. A significant challenge that store operators now face is to maximize the number of customers and also to maximize the dollars spent during any one or multiple visits.

To meet this challenge, many stores are expanding to include a variety of new and diverse products and services. Large amounts of capital are being spent on the development of attractive buildings and other marketing techniques in an effort to expand the retail relationship between the store and the customer.

At the same time this process is occurring, “pay at the pump” technology is becoming widespread in the interest of adding further convenience for the customer base and to allow for higher traffic volume for fuel purchases. The problem this presents is two-fold. First, the fuel purchases represent a relatively low profit margin for the store. Second, the well designed buildings and higher margin retail products located on the store shelves are generally ignored by customers who are interested in purchasing fuel. If the customer does not enter the store, the customer does not purchase the higher margin retail products.

What is needed, therefore, is an effective marketing program and related apparatus to increase the purchase of both fuel and non-fuel products at stores.

### BRIEF SUMMARY OF THE INVENTION

The present invention is directed to an apparatus for providing a purchaser of fuel a chance to win an award. The apparatus includes a fuel pump for dispensing fuel purchased by the fuel purchaser at a store. An electronic processing system in electrical communication with the fuel pump produces a unique identifier for the fuel purchase. A customer interface device, such as a kiosk, located in the store is configured to receive the unique identifier from the purchaser and provide the purchaser an opportunity to win an award based on chance.

The unique identifier may take a number of forms. In one embodiment, the unique identifier is a number. The number may be printed on a fuel purchase receipt and manually input to the kiosk by the fuel purchaser. Alternatively, the unique identifier may be represented by a bar code or stored on an electrically readable storage medium that is read by the kiosk.

The kiosk may be configured in a variety of ways to determine whether a fuel purchaser with a valid unique identifier wins an award. For example, in one embodiment the kiosk generates a random number that is compared to a portion of the fuel purchase amount, such as the cents portion. If the randomly generated number matches the cents portion of the fuel purchase amount, the fuel purchaser wins an award.

The customer interface device may also be operable to dispense a short duration coupon that is redeemable for a period of 24 hours or less. In addition, the customer interface device may be further operable to validate the unique identifier and to provide the purchaser an opportunity to win an award only if the unique identifier is validated.

The present invention is also directed to a method for providing a purchaser of fuel a chance to win an award. In accordance with the method, a fuel pump is provided for dispensing fuel purchased by a fuel purchaser at the store. A unique identifier is produced for the fuel purchase with an electronic processing system that is in electrical communication with the fuel pump. The unique identifier is provided to a customer interface device, such as a kiosk, that is located in the store. The kiosk then determines whether the fuel purchaser wins an award based on chance.

In accordance with a further aspect of the method, the unique identifier may be validated before the purchaser is given an opportunity to win an award.

The fuel purchaser may be given an opportunity to win an award based on chance in a number of ways. For example, in one embodiment, a random number is generated and compared to a portion of the fuel purchase amount, such as the cents portion. If the randomly generated number matches the cents portion of the fuel purchase amount, the fuel purchaser wins an award.

The fuel purchaser may also be provided with a short duration coupon that is redeemable for a period of 24 hours or less.

### BRIEF DESCRIPTION OF THE DRAWINGS

Preferred embodiments of the invention will now be described in further detail. Other features, aspects, and advantages of the present invention will become better understood with regard to the following detailed description and accompanying drawings (which are not to scale) where:

FIG. 1 is a block diagram of a convenience store facility incorporating an incentive marketing apparatus and method according to the invention;

FIG. 2 is a plan view of a fuel purchase receipt configured for use in an incentive marketing program according to the invention;

FIG. 3 is a block diagram of a kiosk and its interface to a point of sale processing system and commercial transaction database according to the invention;

FIG. 4 is a plan view of a series of screen shots generated by the kiosk of FIG. 3;

FIG. 5 is a flow diagram of an incentive marketing method according to the invention; and

FIG. 6 is a plan view of a short duration coupon according to the invention.

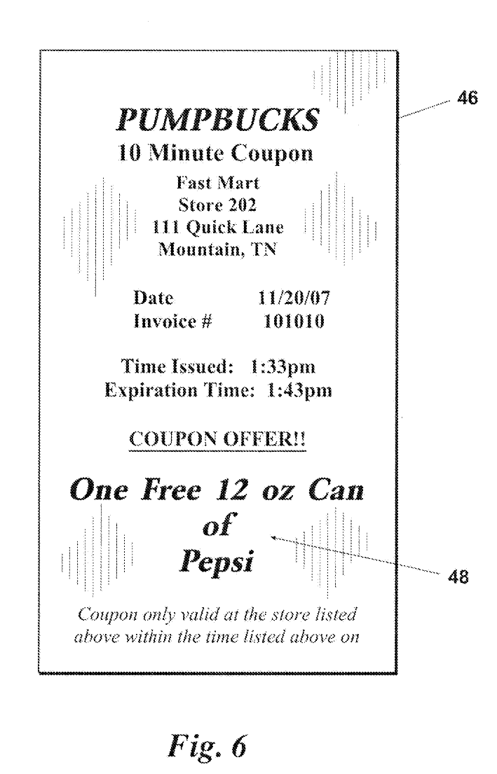

### DETAILED DESCRIPTION OF THE PREFERRED EMBODIMENT(S)

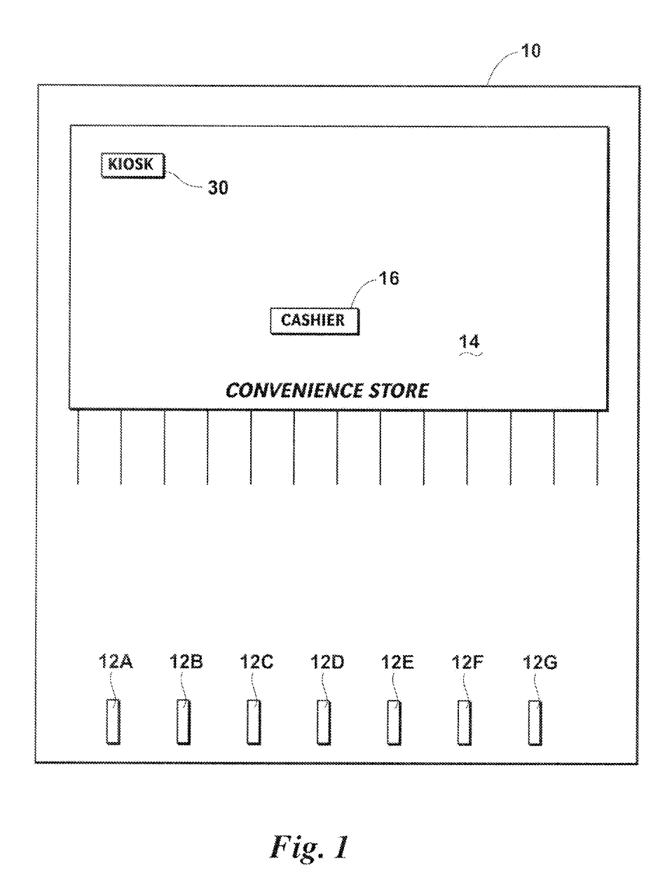

Turning now to the drawings wherein like reference characters indicate like or similar parts throughout, there is shown in FIG. 1 an arrangement of facilities for a typical store center 10 having a plurality of fuel pumps 12A-G and a store 14 such as a convenience store or a grocery store. Customers of the store center 10 are able to purchase fuel at the pumps 12A-G. Fuel purchases may be by cash payment at the cashier 16 located in the store 14 or by any suitable “pay at the pump” method, which primarily involves the use of a credit or debit card. Pay at the pump purchasers of fuel are usually not required to enter the store 14.

Retail products offered for sale within the store 14 typically represent a higher profit margin than sales of fuel. Many customers of the store center 10 are only interested in purchasing fuel, and when these customers utilize one of the available pay at the pump methods, the customer does not enter the store 14 and the store 10 is unable to sell its higher profit margin retail products to the customer.

By use of an incentive marketing program apparatus and method as herein described, the store center 10 is able to increase the overall customer base, bring more fuel purchase customers into the store 14 and ultimately create additional incentives for customers to purchase retail items once inside the store 14. In general, the incentive marketing program apparatus and method uses a gaming approach, referred to herein as the PumpBucks game, combined with unique coupon incentives to increase customer traffic and sales.

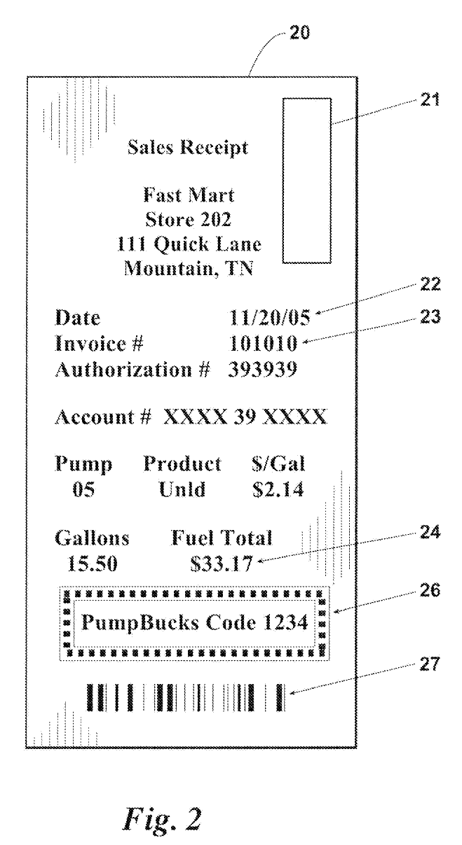

When a customer makes a fuel purchase at a fuel pump 12A-G, a receipt 20 (FIG. 2) is generated at the pump 12A-G. Alternatively, the receipt 20 may be generated inside the store 14. In either case, the customer must enter the store 14 to play the PumpBucks game. The receipt 20 includes information and/or indicia required to play the PumpBucks game. In a preferred embodiment, the receipt 20 is a paper receipt with fuel purchase information printed thereon, including the current date 22, an invoice number 23, the amount of the fuel purchase in dollars and cents 24, and a bar code 27 representation of the invoice number 23 or other unique identifier for the fuel purchase. Alternatively, the receipt 20 may include an electronically readable storage medium (such as a magnetic strip 21) on which fuel purchase information is digitally stored. For purposes of illustration, the receipt 20 of FIG. 2 includes a date of Nov. 20, 2005, an invoice number of 101010, and a fuel purchase amount of $33.17. These values are used herein in an exemplary fashion to help illustrate how the PumpBucks game is played. A short set of game instructions may also be provided on or in addition to the receipt 20.

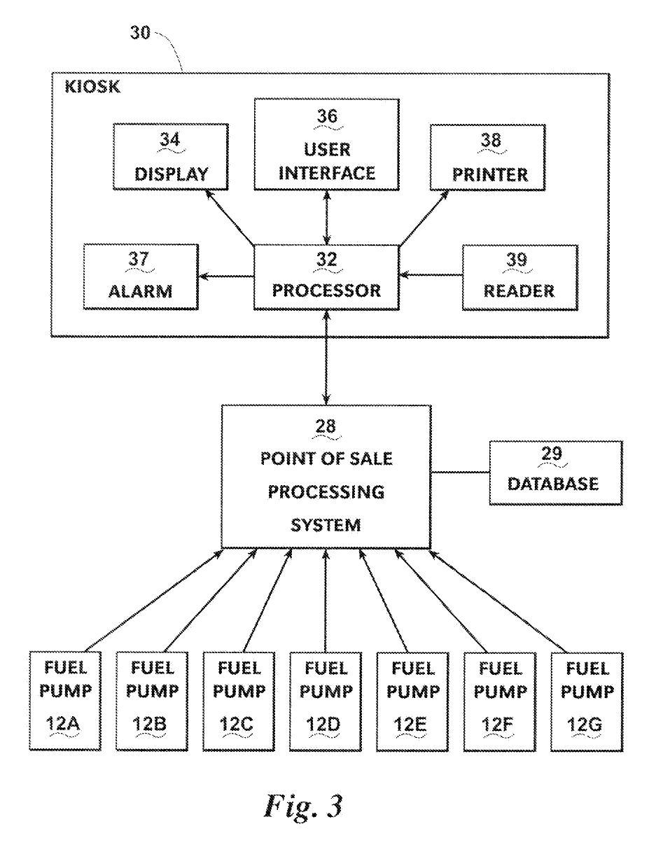

As shown in FIG. 3, each of the fuel pumps 12A-G is in electrical communication with the store's electronic point of sale (POS) processing system 28. The POS processing system 28 is in electrical communication with a database 29 configured to track, store and manage the store's commercial transactions. By “electrical communication”, what is meant is that data and other information is communicated by a hard-wired connection(s) or wirelessly (such as by RF or infrared link). Accordingly, when a fuel purchase is completed at one of the fuel pumps 12A-G, the particulars of that transaction (including the date 22, invoice number 23 and purchase amount 24) are routed to and recorded in the database 29. The database 29 may also be used to track, store and manage the commercial transactions of other affiliated stores and may be located off premises from the store center 10. The POS processing system 28 also generates a bar code 27 representing the invoice number 23 or other unique identifier for the fuel purchase.

After purchasing fuel, the customer takes the receipt 20 in hand and enters the store 14. Within the store 14 is a kiosk 30 or similar customer interface device that can be utilized by the customer to play the PumpBucks game. The kiosk 30 includes a digital processor 32 with the requisite programming to enable the fuel purchase customer to play the PumpBucks game, a display 34 and a user input/interface device 36. In a preferred embodiment, the display 34 is a touch screen display that also functions as the user interface 36. In an alternate embodiment, the user interface 36 is a keyboard, keypad, bar code reader or other on or off screen device to enable the customer to interface with the kiosk. The kiosk 30 is preferably connected to the Internet to facilitate software upgrades and data exchange.

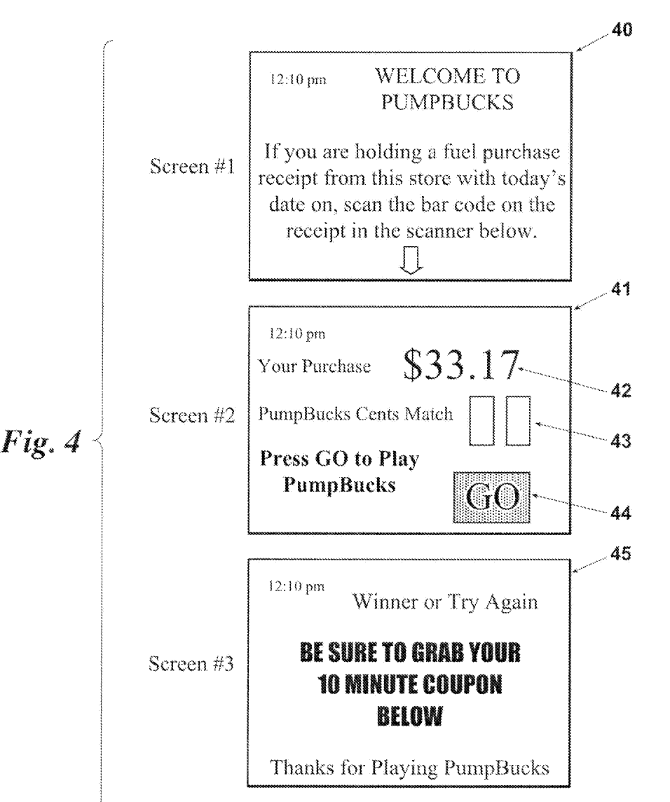

In the touch screen embodiment, the customer views an initial screen (Screen #1) 40 as shown in FIG. 4. A customer with a fuel purchase receipt 20 may initiate the PumpBucks game by inputting the invoice number 23 or other unique identifier into the kiosk 30, which in one embodiment is in electrical communication with the POS processing system 28. Preferably, this is done by scanning the receipt bar code 27 (or magnetic strip 21) with a reader 39 located at the kiosk 30. Alternatively, the customer may manually input the invoice number 23 with the user interface 36. After the customer scans or otherwise inputs the bar code 27 or other unique identifier of the fuel purchase, the kiosk 30 ascertains the invoice number 23 from the bar code representation and may transmit the invoice number 23 to the store's POS processing system 28. The POS processing system 28 or the kiosk 30, or both, then preferably checks to determine whether the invoice number 23 is valid. The database 29 is used to check the invoice for validity. If the invoice number 23 is valid, the customer is allowed to play the PumpBucks game. If the invoice number 23 is valid, the customer is so informed at the kiosk 30. Circumstances which may result in finding the invoice number 23 to be invalid include an invoice number 23 that is not recognized by the database 29, an invoice number 23 that has already been used to play the PumpBucks game, and an invoice number 23 that corresponds to a non-qualifying purchase, such as a purchase that was made prior to the most recent 24-hour period of time. If the invoice number 23 is valid, a second screen (Screen #2) 41 is displayed showing the purchase amount 24 at area 42 in dollars and cents. Displayed adjacent to the purchase amount area 42 is a two-digit cents match area 43 that is randomly populated by the kiosk 30 or, alternatively, the POS processing system 28 when the customer presses the appropriate on-screen button 44. If the randomly generated two-digit match number appearing at cents match area 43 matches the cents amount displayed at purchase amount area 42, the customer is informed at Screen #3 45 that he is a winner. For the exemplary purchase amount of $33.17 used herein, a match number of “17” at area 43 will produce a winning receipt 20. Alternatively, other forms of chance may be employed to determine whether the customer is a winner.

In another preferred embodiment, the kiosk 30 operates autonomously from the POS processing system 28. In this embodiment, if the unique identifier is checked for validity, it will be found invalid only if it has already been used to play the PumpBucks game. In order to claim an award, however, the customer should be required to present the winning receipt 20.

A winning receipt 20 can be redeemed at the cashier 16 for a cash award or other form of award. In a preferred embodiment, the award is a cash award equal to the dollar amount of the fuel purchase. By matching the cents, the customer wins the dollars. Thus, winners of the PumpBucks game can essentially receive the fuel they have just purchased for free. Preferably, an aural and/or visual alarm 37 is initiated by processor 32 as an indication to others that a customer has just won the PumpBucks game. If an exact match of the cents amount at area 42 and the match number at area 43 does not occur, the customer is encouraged at Screen #3 45 to try again next time.

Regardless of whether the PumpBucks game player is a winner, after the customer presses button 44, a short-duration coupon (such as 10 minutes) is preferably dispensed by a dispenser by printer 38. Alternatively, coupon 46 may be pre-printed and dispensed by the kiosk 30. The 10-minute coupon 46 has a 10-minute time during which the customer must redeem the coupon 46 at the cashier 16 for the retail product 48 specified on the coupon 46. The coupon 46 may have a longer or shorter duration than 10 minutes, but is preferably of sufficiently short duration that the customer will expect the coupon 46 to expire before the customer's next visit to the store 14. The coupon 46 is preferably valid for only 10 minutes, but may have an expiration time of up to 24 hours from when the customer presses button 44. In this manner, the coupon 46 provides a tremendous incentive for customers to make the discounted purchase because the customer knows that in all likelihood, if he leaves the store 14 without making the discounted purchase, the coupon 46 will lose its value before the customer's next visit. The concept of a 10-minute/short duration coupon 46 also recognizes that many customers of stores such as convenience stores are travelers who are one-time or infrequent customers and an immediate sale is the only opportunity the retailer has for incremental purchases beyond fuel.

In an alternate embodiment of the PumpBucks game and the method in which it is played, the customer manually enters into the kiosk 30 information necessary to play the game. For example, the customer may manually enter the invoice number 23 as opposed to having it scanned in with a bar code reader 39. In this embodiment, the kiosk 30 transmits the invoice number 23 to the POS processing system 28 for validation or to an internal validation database or to an external validation database via the Internet. Alternatively, the customer may manually enter a game code 26 printed on the receipt 20. The game code 26 corresponds to fuel purchase information needed to play the game. The corresponding fuel purchase information may be stored at database 29 (in which case database 29 validates the game code 26), in memory residing locally at kiosk 30 (kiosk 30 performs game code validation), or in memory residing in POS processing system 28 (POS processing system 28 performs game code validation).

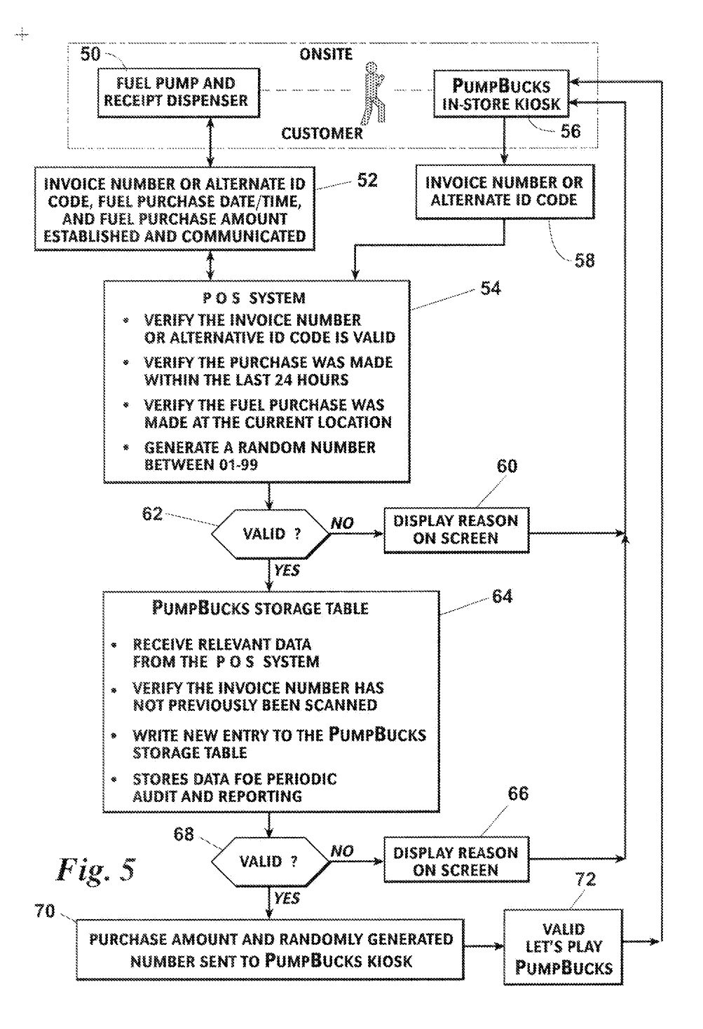

FIG. 5 provides a flow diagram of a method for increasing business at a store where a fuel purchase customer receives a receipt with information needed to play the PumpBucks game. The customer carries the fuel purchase receipt to an in-store kiosk 56 and enters fuel purchase information from the receipt, such as invoice number, game code 58, or some other unique identifier into the kiosk. The kiosk transmits the fuel purchase information 58 to the POS processing system 54 which validates the invoice number, game code or other unique identifier and verifies that the fuel purchase qualifies for game play. If the POS processing system is unable to validate the fuel purchase information, the customer is so informed 60. If the POS processing system is able to validate the fuel purchase information 62, the customer is allowed an opportunity to win an award based on chance. In such event, the POS processing system 54 is preferably configured to randomly generate a number that will determine whether the customer wins an award. A PumpBucks storage table 64, preferably residing in the POS processing system, is also updated with relevant fuel purchase data. Information in the storage table is used to verify that the fuel purchase has not already been used to play the game. If the fuel purchase has already been used to play the game, there will be an entry indicating such in the storage table and the subsequent attempt to play will be invalidated 66. If the fuel purchase has not already been used to play the game, the fuel purchase is further validated 68 and a new entry is written into the storage table.

After validation of the fuel purchase information, the POS processing system 28 or the kiosk 30 randomly generates a number that is compared to the fuel purchase amount or a portion of the fuel purchase amount. In a preferred embodiment, the POS processing system 28 randomly generates a two-digit number that is communicated to the kiosk 70 and the customer is allowed to play 72. At this point, the kiosk compares the randomly generated two-digit number to the cents amount of the fuel purchase amount and if an exact match occurs, the customer wins an award. If there is no match, the customer is invited to play again. Regardless of whether the customer wins, the customer receives a short duration coupon, such as a 10-minute coupon, just for playing the award game.

With continued reference to FIG. 5, information contained in the storage table 64 can be used to conduct periodic audits and activity reports. Such audits and reports can be utilized, for example, by the store operator to verify that awards and coupons being honored by the cashier are commensurate with activity that has been recorded in the storage table.

Through the incentive of an award game as herein described, customers are more inclined to purchase their fuel from stores that offer the PumpBucks game. Thus, customer traffic into the participating store center 10 is significantly increased. After purchasing fuel, the customer is given an incentive to enter the store 14 to play the PumpBucks game in the hope of winning an award. This incentive is further enhanced by the fact that the game must be played on the same day that the fuel purchase is made. Thus, in-store customer traffic is significantly increased and the store center is able to increase its higher profit margin retail sales through impulse buying and the like.

What is claimed is:

1. An apparatus for providing a purchase of fuel a chance to win an award, the apparatus comprising:
a fuel pump for dispensing fuel purchased by a purchaser at a store;
an electronic processing system in electrical communication with said fuel pump for producing a unique identifier for the fuel purchase; and
a customer interface device located in the store, said customer interface device being configured to receive the unique identifier from the purchaser and to provide the purchaser an opportunity to win an award based on chance.

2. The apparatus of claim 1 wherein said unique identifier is included on a fuel purchase receipt.

3. The apparatus of claim 1 wherein said unique identifier is a number.

4. The apparatus of claim 1 wherein said unique identifier is represented by a bar code that can be read by the customer interface device.

5. The apparatus of claim 1 wherein said unique identifier is represented by an electronically readable storage medium that can be read by the customer interface device.

6. The apparatus of claim 1 wherein said customer interface device is a kiosk.

7. The apparatus of claim 1 wherein said customer interface device is configured to provide the purchaser an opportunity to win an award based on chance by:
generating a random number; and
comparing the randomly generated number to a portion of the fuel purchase amount to determine if the purchaser wins an award.

8. The apparatus of claim 7 wherein said randomly generated number is a two-digit number that is compared to the cents portion of the fuel purchase amount.

9. The apparatus of claim 1 wherein said customer interface device is operable to dispense a short duration coupon that is redeemable for a period of 24 hours or less.

10. The apparatus of claim 1 wherein said customer interface device is further operable to validate the unique identifier and to provide the purchaser an opportunity to win an award only if the unique identifier is validated.

11. An apparatus for providing a purchase of fuel a chance to win an award, the apparatus comprising:
a fuel pump for dispensing fuel purchased by a purchaser at a store;
an electronic processing system in electrical communication with said fuel pump for producing a unique identifier for the fuel purchase; an
a customer interface device located in the store, said customer interface device being configured to receive the unique identifier from the purchaser and to provide the purchaser an opportunity to win an award based on chance by generating a random number and comparing the randomly generated number to a portion of the fuel purchase amount to determine if the purchaser wins an award.

12. The apparatus of claim 11 wherein said randomly generated number is a two-digit number that is compared to the cents portion of the fuel purchase amount.

13. The apparatus of claim 11 wherein said customer interface device is further operable to dispense a short duration coupon that is redeemable for a period of 24 hours or less.

14. The apparatus of claim 11 wherein said customer interface device is further operable to validate the unique identifier and to provide the purchaser an opportunity to win an award only if the unique identifier is validated.

15. A method of providing a purchaser of fuel a chance to win an award, the method comprising:
providing a fuel pump for dispensing fuel purchased by a fuel purchaser at a store;
producing a unique identifier for the fuel purchase with an electronic processing system that is in electrical communication with the fuel pump;
providing the unique identifier to a customer interface device that is located in the store; and
determining by chance whether the fuel purchaser wins an award.

16. The method of claim 15 wherein the step of determining by chance whether the fuel purchaser wins an award further includes:
generating a random number; and
comparing the randomly generated number to a portion of the fuel purchase amount to determine if the purchaser wins an award.

17. The method of claim 16 wherein said randomly generated number is a two-digit number that is compared to the cents portion of the fuel purchase amount.

18. The method of claim 15, further comprising:
printing the unique identifier on a fuel purchase receipt; and
manually inputting the unique identifier to the customer interface device.

19. The method of claim 15, further comprising:
representing the unique identifier with a bar code; and
reading the bar code with the customer interface device.

20. The method of claim 15, further comprising:
storing the unique identifier on an electronically readable medium; and
reading the electronically readable medium with the customer interface device.

21. The method of claim 15, further comprising:
checking the unique identifier to determine whether the unique identifier is valid.

22. The method of claim 15, further comprising:
providing the fuel purchaser with a short duration coupon that is redeemable for a period of 24 hours or less.
